(19) United States
(12) Patent Application Publication
(10) Pub. No.: US 2026/0213106 A1
(43) Pub. Date: Jul. 23, 2026

(54) CIRCUIT BREAKER

(71) Applicant: FUJI ELECTRIC FA COMPONENTS & SYSTEMS CO., LTD., Konosu-shi (JP)

(72) Inventor: Kazuki NAGAMINE, Saitama-city (JP)

(73) Assignee: FUJI ELECTRIC FA COMPONENTS & SYSTEMS CO., LTD., Konosu-shi (JP)

(21) Appl. No.: 19/437,954

(22) Filed: Dec. 31, 2025

(30) Foreign Application Priority Data
Jan. 17, 2025 (JP) 2025-006784

(51) Int. Cl. H01H 71/52; H01H 9/34; H01H 71/02

(52) U.S. Cl. CPC H01H 71/527; H01H 9/34; H01H 71/0207; H01H 71/025

(57) ABSTRACT

A second link constitutes another part of a toggle link in an open-close mechanism, has one end rotatably connected to a toggle pin and another end rotatably connected to a movable holder, and opens and closes a contact by causing the movable holder to rotate. A partition wall separates the open-close mechanism side and the movable holder side and has a slot for the second link. The second link is formed in an outer shape in which at a central portion of a path extending from one end to another end when viewed from a width direction, both an outline on a power supply side and an outline on a load side are drawn closer to a power supply side. The slot is set so that a gap is minimized within a range not causing interference with movement of the second link.

### CROSS REFERENCE TO RELATED APPLICATIONS AND INCORPORATION BY REFERENCE

This application claims benefit of priority under 35 USC 119 based on Japanese Patent Application No. 2025-006784 filed on Jan. 17, 2025, the entire contents of which are incorporated by reference herein.

### TECHNICAL FIELD

The present invention relates to a circuit breaker.

### BACKGROUND ART

In a circuit breaker described in JP 2007-52942 A, opening and closing of contacts is performed by second links of toggle links rotating a movable holder, and slots (through-holes) for the second links are formed in a partition wall that separates the open-close mechanism side from the contact side. To prevent arc gas from escaping to the open-close mechanism side through gaps in the slots when the circuit breaker is turned off, protrusions are formed on the second links and the gaps in the slots are thereby reduced in size.

### SUMMARY OF INVENTION

### Technical Problem

Although in a configuration in which protrusions are formed on the second links of the toggle links, the gaps when the circuit breaker is turned off can be reduced in size, there has been room for improvement in reducing in size gaps when the circuit breaker is tripped. Since when arc gas escapes through the gaps in the slots, driving force of the arc decreases, breaking performance is affected.

An object of the present invention is to, in a circuit breaker, suppress arc gas from escaping from a slot for a second link constituting a toggle link when the circuit breaker is tripped and improve breaking performance of the circuit breaker.

### Solution to Problem

A circuit breaker according to one aspect of the present invention includes a second link and a partition wall. The second link constitutes another part of a toggle link in an open-close mechanism, has one end rotatably connected to a toggle pin and another end rotatably connected to a movable holder, and is configured to open and close a contact by causing the movable holder to rotate. The partition wall is disposed to separate the open-close mechanism side and the movable holder side from each other and has a slot for the second link formed. A direction in which the toggle pin extends is aligned with a width direction. The second link is formed in an outer shape in which at a central portion of a path extending from one end to another end when viewed from a width direction, both an outline on a power supply side and an outline on a load side are drawn closer to a power supply side. The slot is set in such a way that a gap is minimized within a range not causing the slot to interfere with movement of the second link.

A circuit breaker according to another aspect of the present invention includes a second link and a partition wall. The second link constitutes another part of a toggle link in an open-close mechanism, has one end rotatably connected to a toggle pin and another end rotatably connected to a movable holder, and is configured to open and close a contact by causing the movable holder to rotate. The partition wall is disposed to separate the open-close mechanism side and the movable holder side from each other and has a slot for the second link formed. A direction in which the toggle pin extends is aligned with a width direction. The second link is formed in an outer shape in which a central portion of a path extending from one end to another end when viewed from a width direction is bent into a V-shape to protrude toward a power supply side. The slot is set in such a way that a gap is minimized within a range not causing the slot to interfere with movement of the second link.

### Advantageous Effects of Invention

According to the present invention, a gap of the slot can be minimized by the second link. Therefore, it is possible to suppress arc gas from escaping from the slot when the circuit breaker is tripped and improve breaking performance of the circuit breaker.

### BRIEF DESCRIPTION OF DRAWINGS

FIG. 1 is a diagram illustrative of a circuit breaker;

FIG. 2 is a diagram illustrative of a cross section of the circuit breaker;

FIGS. 3A and 3B are diagrams illustrative of a case;

FIGS. 4A and 4B are diagrams illustrative of a second link;

FIG. 5 is a diagram illustrative of a movable holder and the second links;

FIG. 6 is a diagram illustrative of the case and the movable holder;

FIGS. 7A and 7B are diagrams illustrative of a partition wall of a middle cover;

FIG. 8 is a diagram illustrative of the middle cover and the second links;

FIG. 9 is a diagram illustrative of the second link when the circuit breaker is turned on;

FIG. 10 is a diagram illustrative of the second link when the circuit breaker is turned off; and

FIG. 11 is a diagram illustrative of the second link when the circuit breaker is tripped.

### DESCRIPTION OF EMBODIMENTS

An embodiment of the present invention will be described below, based on the drawings. Note that the respective drawings are schematic and do not necessarily depict the actual dimensions or precise configurations of practical implementation of the present invention. In addition, the following embodiment indicates a device and a method to embody the technical idea of the present invention by way of example, and do not limit the configuration to that described below. That is, the technical idea of the present invention can be subjected to a variety of alterations within the technical scope described in the claims.

### Embodiment

### Configuration

In the following description, for descriptive purposes, three directions orthogonal to one another are assumed to be a vertical direction, a width direction, and a depth direction.

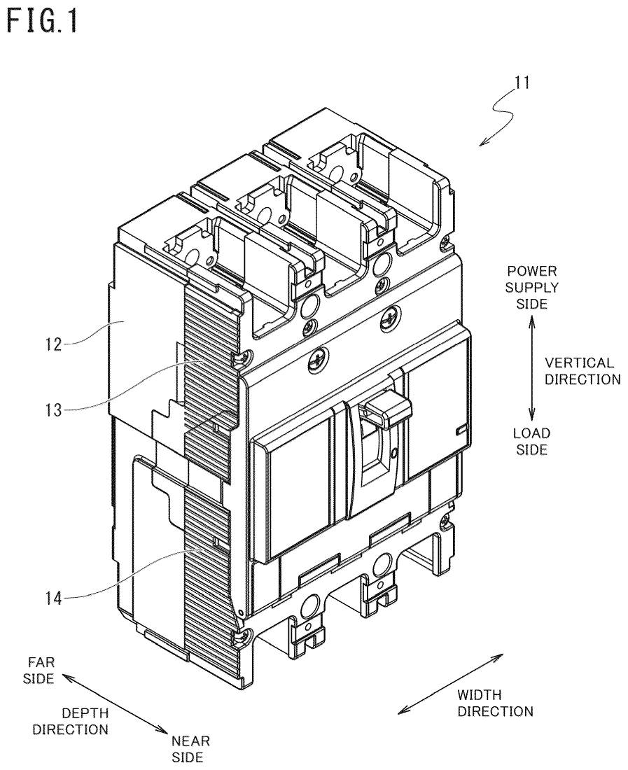

FIG. 1 is a diagram illustrative of a circuit breaker 11.

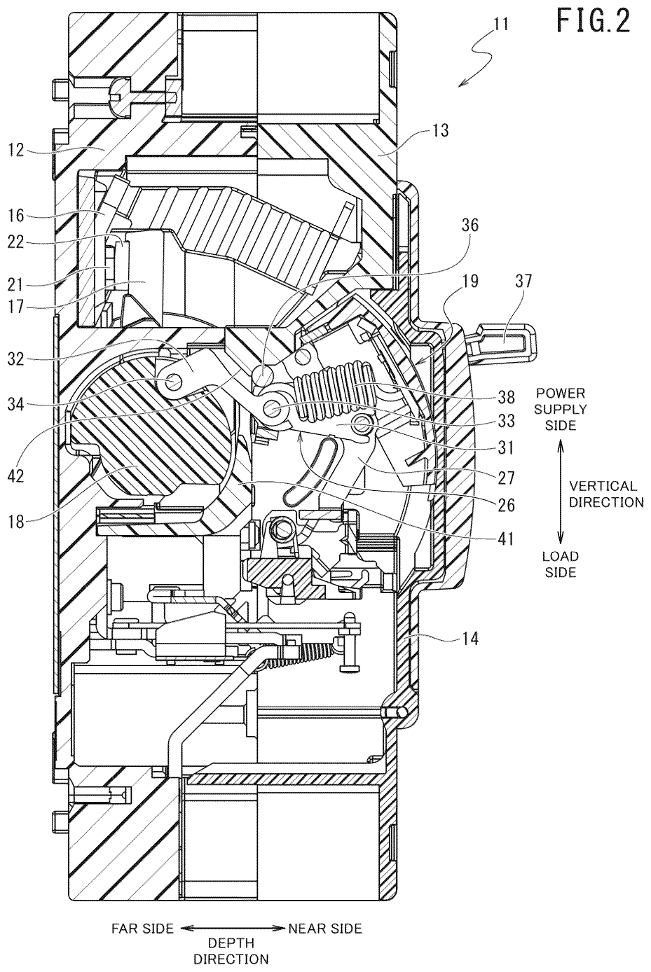

In this drawing, the circuit breaker 11 when viewed from one side in the vertical direction, one side in the width direction, and a near side in the depth direction is illustrated. The circuit breaker 11, also referred to as a no-fuse breaker, is designed to automatically shut off a circuit to protect the circuit from damage due to overcurrent when an abnormal overcurrent due to overload or short-circuit is detected. In the vertical direction, one side serves as a power supply side, and the other side serves as a load side. The circuit breaker 11 includes, as a resin-made housing, a case 12, a middle cover 13, and a top cover 14. The case 12 is arranged on a far side in the depth direction, the middle cover 13 is fitted to the case 12 on the power supply side, and the top cover 14 is fitted to the case 12 and the middle cover 13 on the load side (FIG. 2).

FIG. 2 is a diagram illustrative of a cross section of the circuit breaker 11.

In this drawing, a cross section of the circuit breaker 11 that passes a portion corresponding to a second pole positioned at the center in the width direction among three portions corresponding to three poles arranged in the width direction and that extends along the vertical direction and the depth direction when viewed from the one side in the width direction is illustrated. The circuit breaker 11 includes fixed contact pieces 16, movable contact pieces 17, a movable holder 18, and an open-close mechanism 19.

Each fixed contact piece 16 is a belt-shaped conductor fixed to the power supply side of the case 12, and a fixed contact 21 is formed on a surface of the fixed contact piece 16 facing the near side in the depth direction.

Each movable contact piece 17 is a rod-shaped conductor held by the movable holder 18 and is rotatably supported between a contact-closing position and a contact-opening position. As viewed from the one side in the width direction, a counterclockwise direction is a contact-closing direction, and a clockwise direction is a contact-opening direction. On the movable contact piece 17, a movable contact 22 is formed on a tip end side of a surface facing the contact-closing direction. The movable contact piece 17 is brought into an on state in which electrodes (contacts) are closed when the movable contact 22 comes into contact with a fixed contact 21, and is brought into an off state in which the electrodes (contacts) are opened when the movable contact 22 separates from the fixed contact 21.

The movable holder 18 is rotatably held by the case 12 and the middle cover 13, and rotates the movable contact pieces 17 in an interlocking manner with movement of the open-close mechanism 19. When the open-close mechanism 19 is brought into the on state, the movable holder 18 rotates the movable contact pieces 17 to the contact-closing position, and when the open-close mechanism 19 is brought into the off state or a tripped state, the movable holder 18 rotates the movable contact pieces 17 to the contact-opening position.

The open-close mechanism 19 includes toggle links 26 and a latch 27. Each toggle link 26 includes a first link 31 and a second link 32. The other end of the first link 31 and one end of the second link 32 are rotatably connected via a toggle pin 33. One end of the first link 31 is rotatably fitted onto a boss of the latch 27. The other end of the second link 32 is rotatably connected to the movable holder 18 via a connection pin 34.

The latch 27 is rotatably supported by a latch pin 36. The latch 27 is brought into a latched state and fixes the one end of the first link 31 when the circuit breaker 11 is turned on or off, and is brought into a released state and displaces the one end of the first link 31 by rotation when the circuit breaker 11 is tripped.

In the open-close mechanism 19, when a handle 37 is moved to an on position, the toggle links 26 extend against elastic force of tension coil springs 38 and rotate the movable holder 18 to the contact-closing position. In the open-close mechanism 19, when the handle 37 is moved to an off position, the toggle links 26 bend and rotate the movable holder 18 to the contact-opening position. When the open-close mechanism 19 is tripped due to overcurrent or short-circuit current, the latch 27 being released causes the toggle links 26 to bend due to the elastic force of the tension coil springs 38 and the movable holder 18 to rotate to the contact-opening position.

The middle cover 13 includes a partition wall 41. The partition wall 41 is a wall body extending along the vertical direction and the width direction, and is disposed to separate an open-close mechanism 19 side and a movable holder 18 side from each other. In the partition wall 41, slots (through-holes) 42 for the second links 32 are formed.

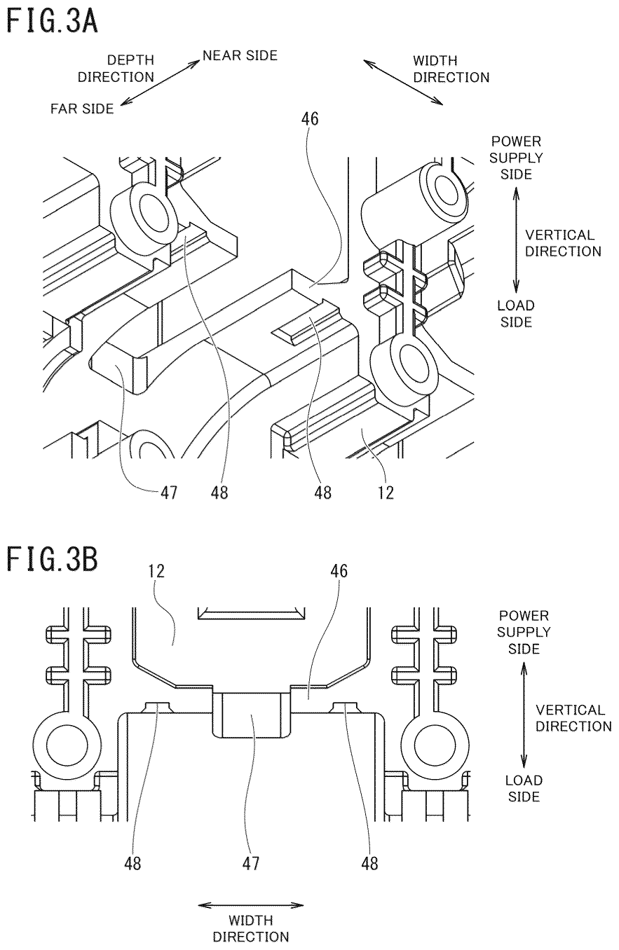

FIGS. 3A and 3B are diagrams illustrative of the case 12.

In FIG. 3A, a portion of the case 12 in which a portion of the movable holder 18 corresponding to the second pole, which is positioned at the center in the width direction, is housed when viewed from the other side in the vertical direction, the one side in the width direction, and the near side in the depth direction is illustrated. In FIG. 3B, the portion of the case 12 in which the portion of the movable holder 18 corresponding to the second pole, which is positioned at the center in the width direction, is housed when viewed from the near side in the depth direction is illustrated. The case 12 includes a dividing wall 46. The dividing wall 46 is a wall body extending along the width direction and depth direction, and faces the power supply side of the portion of the movable holder 18 corresponding to the second pole. On the dividing wall 46, an opening 47 and recessed grooves 48 are formed. The opening 47 is a notch that causes a space on one side to communicate with a space on the other side through the dividing wall 46 in the vertical direction and that is recessed from the near side toward the far side in the depth direction. In the opening 47, a movable contact piece 17 is arranged. The recessed grooves 48 are formed one by one on both sides in the width direction of the opening 47 on a surface of the dividing wall 46 facing the other side in the vertical direction and extend from the near side toward the far side in the depth direction.

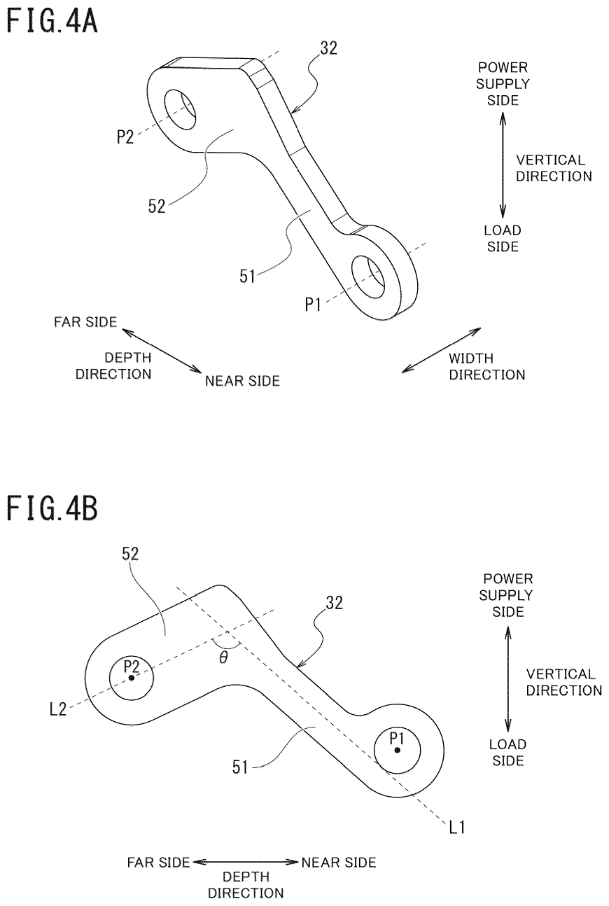

FIGS. 4A and 4B are diagrams illustrative of a second link 32.

In FIG. 4A, the second link 32 when viewed from the one side in the vertical direction, the one side in the width direction, and the near side in the depth direction is illustrated. In FIG. 4B, the second link 32 when viewed from the one side in the width direction is illustrated. The second link 32 is a flat plate made of metal extending along the vertical direction and the depth direction, and includes one piece 51 and the other piece 52. On a one end side of the one piece 51, a circular hole penetrating the one piece 51 in the width direction is formed as a connection point P1 with the other end of the first link 31. On the other end side of the other piece 52, a circular hole penetrating the other piece 52 in the width direction is formed as a connection point P2 with the movable holder 18. The second link 32 is formed in an outer shape in which at a central portion of a path extending from one end to the other end when viewed from the width direction, both an outline on the power supply side and an outline on the load side are drawn closer to the power supply side. In other words, the second link 32 is formed in an outer shape in which the central portion of a path extending from the one end to the other end when viewed from the width direction is bent into a V-shape to protrude toward the power supply side. That is, an axis L1 along which the one piece 51 extends and an axis L2 along which the other piece 52 extends are not parallel, and an angle θ formed by the axis L1 and the axis L2 is an obtuse angle, herein. The connection point P1 is shifted from the axis L1 to the power supply side. The connection point P2 is located on the axis L2.

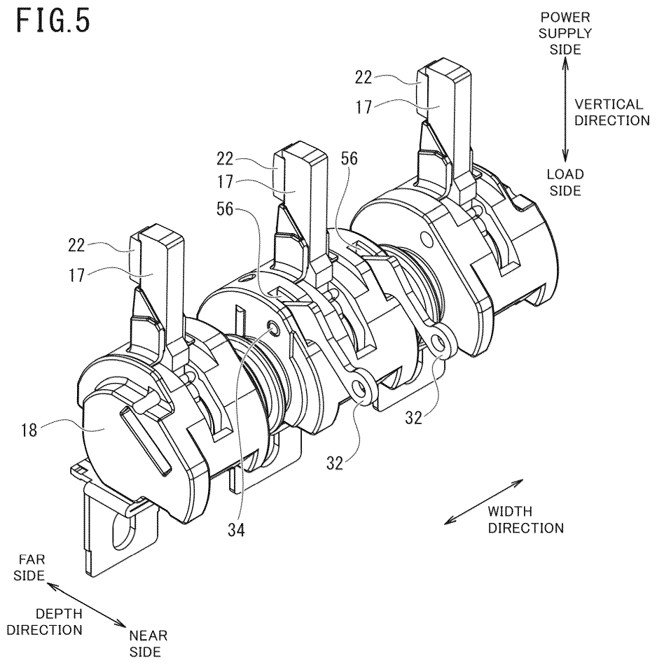

FIG. 5 is a diagram illustrative of the movable holder 18 and the second links 32.

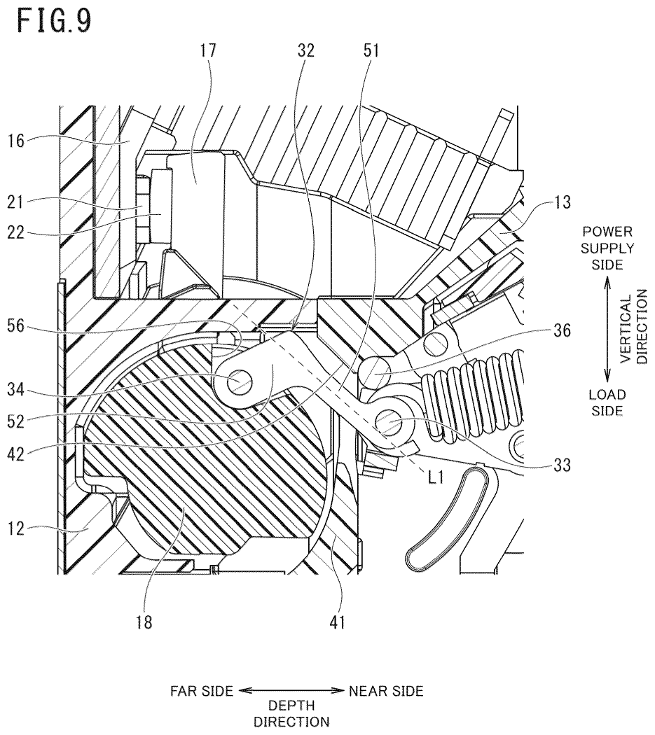

In this drawing, the movable holder 18 into which the second links 32 are assembled when viewed from the one side in the vertical direction, the one side in the width direction, and the near side in the depth direction is illustrated. Each of portions of the movable holder 18 corresponding to the three poles is formed in a substantially cylindrical shape with a portion on the far side in the depth direction and a portion on the load side in the vertical direction opened, and the portions corresponding to the three poles are integrated with each other. On the portion of the movable holder 18 corresponding to the second pole positioned at the center in the width direction, a pair of support holes 56 are formed in the cylindrical surface facing the power supply side in the vertical direction and the near side in the depth direction. The support holes 56 are disposed on both sides sandwiching a movable contact piece 17 in the width direction, and each of the support holes 56 is recessed from the cylindrical surface toward the radially inner side and is formed in a substantially fan shape when viewed from the width direction (FIG. 9). The second links 32 are inserted into the support holes 56 and are rotatably supported by the connection pin 34. The connection pin 34 is inserted from both end surfaces in the width direction of the portion of the movable holder 18 corresponding to the second pole.

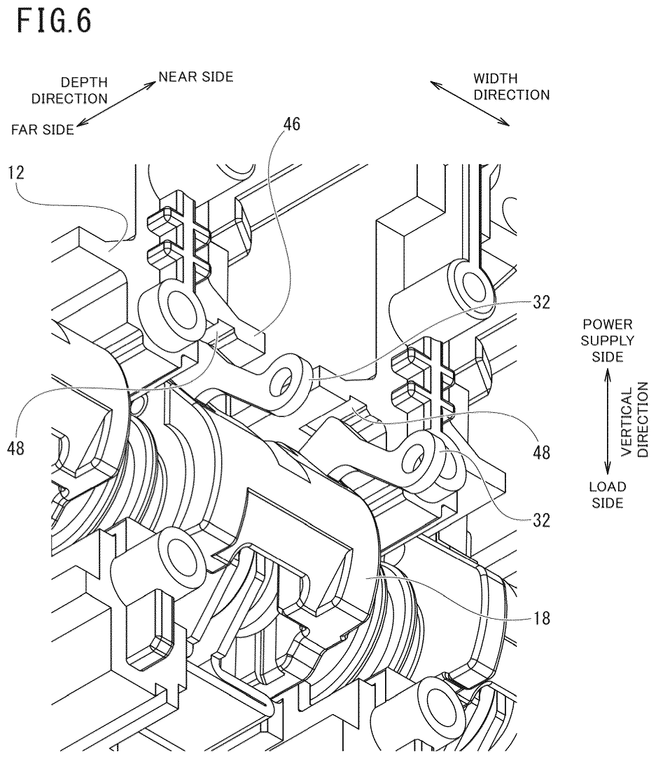

FIG. 6 is a diagram illustrative of the case 12 and the movable holder 18.

In this drawing, the case 12 on which the movable holder 18 is assembled when viewed from the other side in the vertical direction, the one side in the width direction, and the near side in the depth direction is illustrated. The dividing wall 46 of the case 12 avoids interference with the second links 32 by the recessed grooves 48.

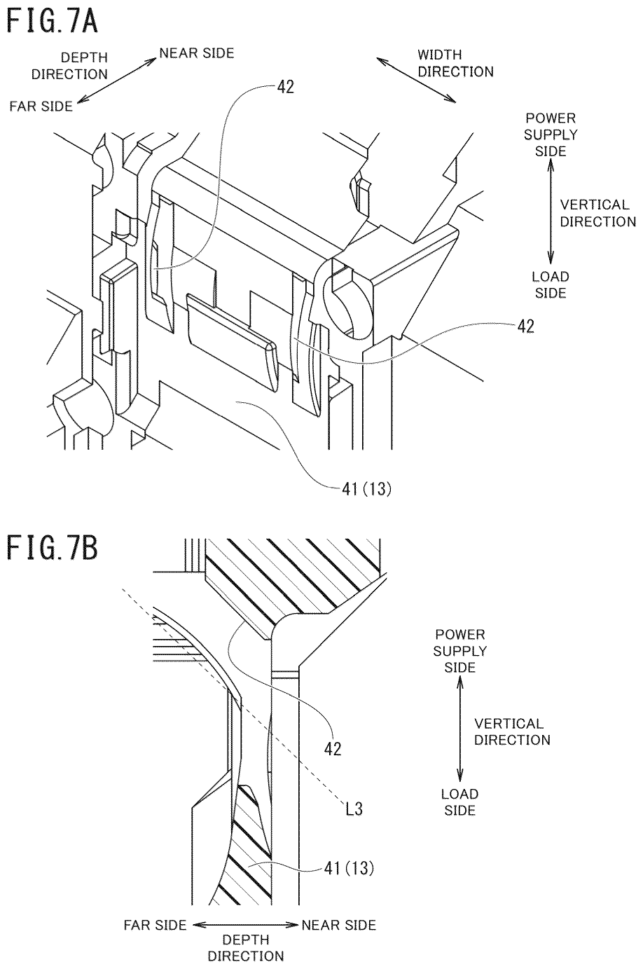

FIGS. 7A and 7B are diagrams illustrative of the partition wall 41 of the middle cover 13.

In FIG. 7A, the partition wall 41 of the middle cover 13 when viewed from the other side in the vertical direction, the one side in the width direction, and the near side in the depth direction is illustrated. In FIG. 7B, a cross section of the partition wall 41 of the middle cover 13 passing one of the slots 42 and extending along the vertical direction and the depth direction when viewed from the one side in the width direction is illustrated. Each of the slots 42 is a narrow rectangular long hole with a cross-sectional shape along the vertical direction and the depth direction extending in the vertical direction, and obliquely penetrates through the partition wall 41 along an axis L3 that extends toward the one side in the vertical direction as extending toward the far side in the depth direction when viewed from the width direction. In each of the slots 42, one of the second links 32 is inserted. Each of the slots 42 is set in such a way that a gap is minimized within a range not causing the slot 42 to interfere with movement of the second link 32.

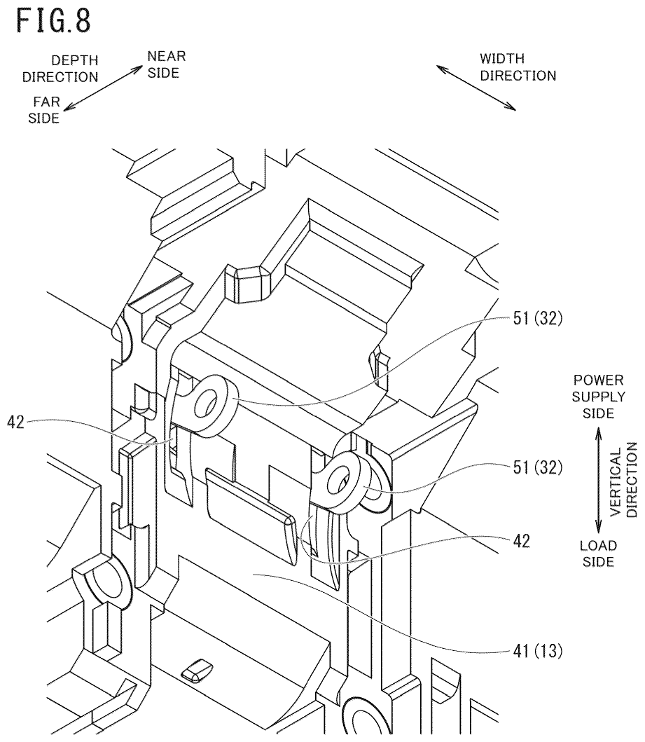

FIG. 8 is a diagram illustrative of the middle cover 13 and the second links 32.

In this drawing, the middle cover 13 that is assembled to the case 12 when viewed from the other side in the vertical direction, the one side in the width direction, and the near side in the depth direction is illustrated. Each of the second links 32 has only the one end side of the one piece 51 projecting from the partition wall 41.

FIG. 9 is a diagram illustrative of one of the second links 32 when the circuit breaker 11 is turned on.

In this drawing, a cross section of the circuit breaker 11 extending along the vertical direction and the depth direction with the second link 32 passing one of the slots 42, when viewed from the one side in the width direction is illustrated. When the circuit breaker 11 is in the on state, the second link 32 is located on the far side in the depth direction, and only the one piece 51 is present inside the slot 42. On this occasion, when viewed from the width direction, the axis L1 of the one piece 51 and a penetrating direction of the slot 42 are substantially parallel with each other.

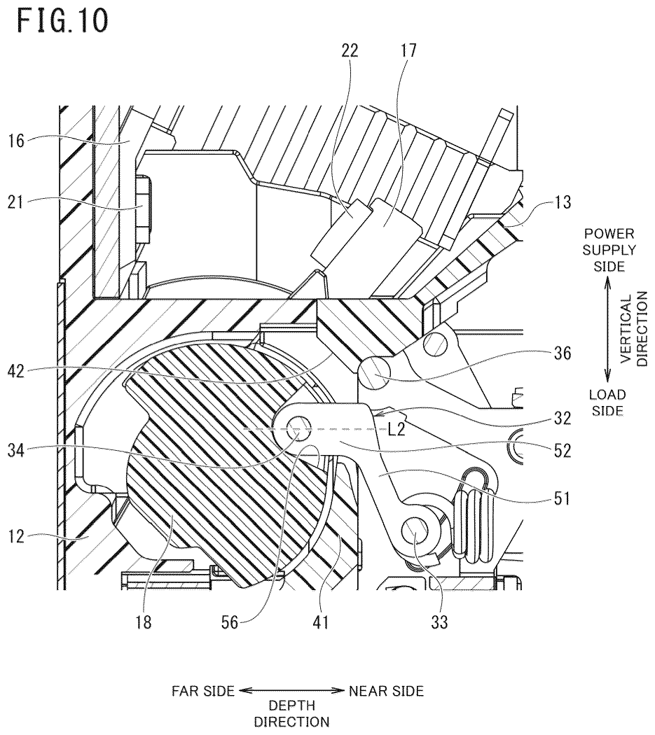

FIG. 10 is a diagram illustrative of the one of the second links 32 when the circuit breaker 11 is turned off.

In this drawing, a cross section of the circuit breaker 11 extending along the vertical direction and the depth direction with the second link 32 passing one of the slots 42, when viewed from the one side in the width direction is illustrated. When the circuit breaker 11 is in the off state, the second link 32 is located on the near side in the depth direction, and only the other piece 52 is present inside the slot 42. On this occasion, when viewed from the width direction, the axis L2 of the other piece 52 is substantially parallel with the depth direction. Since the other piece 52 is located closer to the load side within the slot 42, there is almost no gap on the load side. The latch pin 36, due to being arranged on the open-close mechanism 19 side of the slot 42 and on the power supply side of the second link 32 and crossing an entrance of the slot 42, closes a gap on the power supply side.

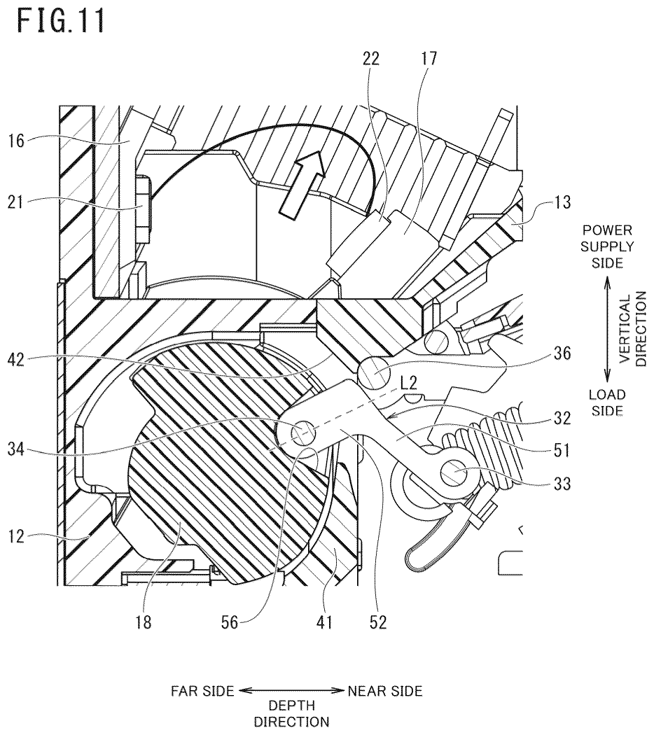

FIG. 11 is a diagram illustrative of the one of the second links 32 when the circuit breaker 11 is tripped.

In this drawing, a cross section of the circuit breaker 11 extending along the vertical direction and the depth direction with the second link 32 passing one of the slots 42, when viewed from the one side in the width direction is illustrated. When the circuit breaker 11 is in the tripped state, the second link 32 is located on the near side in the depth direction, and only the other piece 52 is present inside the slot 42. On this occasion, when viewed from the width direction, the axis L2 of the other piece 52 and the penetrating direction of the slot 42 cross each other at an angle of approximately 90 degrees. Since because of this configuration, when viewed from the width direction, a one end side of the other piece 52 is located closer to the power supply side within the slot 42, there is almost no gap on the power supply side. In addition, since when viewed from the width direction, the other end side of the other piece 52 is located closer to the load side within the slot 42, there is also almost no gap on the load side. Arc gas is discharged from a not-illustrated power supply-side exhaust port, and a flow of the arc gas also facilitates driving an arc towards the arc-extinguishing grid side, as illustrated by a thick solid line. Therefore, by suppressing the arc gas from escaping from the slots 42 to the open-close mechanism 19 side, a majority of the arc gas is guided to the power supply-side exhaust port and the driving force of the arc is thereby enhanced.

### Advantageous Effects

Next, main advantageous effects of the embodiment will be described.

A circuit breaker 11 includes a second link 32 and a partition wall 41. The second link 32 constitutes another part of a toggle link 26 in an open-close mechanism 19, has one end rotatably connected to a toggle pin 33 and another end rotatably connected to a movable holder 18, and is configured to open and close a contact by causing the movable holder 18 to rotate. The partition wall 41 is disposed to separate the open-close mechanism 19 side and the movable holder 18 side from each other and has a slot 42 for the second link 32 formed. A direction in which the toggle pin 33 extends is aligned with a width direction. The second link 32 is formed in an outer shape in which at a central portion of a path extending from one end to another end when viewed from a width direction, both an outline on a power supply side and an outline on a load side are drawn closer to a power supply side. The slot 42 is set in such a way that a gap is minimized within a range not causing the slot 42 to interfere with movement of the second link 32. Because of this configuration, a gap of the slot 42 can be minimized by the second link 32. Therefore, it is possible to suppress arc gas from escaping from the slot 42 when the circuit breaker 11 is tripped and improve breaking performance of the circuit breaker 11.

A circuit breaker 11 includes a second link 32 and a partition wall 41. The second link 32 constitutes another part of a toggle link 26 in an open-close mechanism 19, has one end rotatably connected to a toggle pin 33 and another end rotatably connected to a movable holder 18, and is configured to open and close a contact by causing the movable holder 18 to rotate. The partition wall 41 is disposed to separate the open-close mechanism 19 side and the movable holder 18 side from each other and has a slot 42 for the second link 32 formed. A direction in which the toggle pin 33 extends is aligned with a width direction. The second link 32 is formed in an outer shape in which a central portion of a path extending from one end to another end when viewed from a width direction is bent into a V-shape to protrude toward a power supply side. The slot 42 is set in such a way that a gap is minimized within a range not causing the slot 42 to interfere with movement of the second link 32. Because of this configuration, a gap of the slot 42 can be minimized by the second link 32. Therefore, it is possible to suppress arc gas from escaping from the slot 42 when the circuit breaker 11 is tripped and improve breaking performance of the circuit breaker 11.

An outer shape of the second link 32 is an outer shape viewed from a width direction when the circuit breaker 11 is turned on or is tripped. Because of this configuration, a gap of the slot 42 can be minimized by the second link 32.

A direction having one side and another side when viewed from a width direction serving as a power supply side and a load side, respectively is aligned with a vertical direction. An outer shape on an other end side of the second link 32 viewed from a width direction when the circuit breaker 11 is turned off extends in a direction orthogonal to a vertical direction. Because of this configuration, a gap on the load side can be minimized.

The circuit breaker 11 includes a dividing wall 46. The dividing wall 46 faces the second link 32 on a power supply side of the movable holder 18. On the dividing wall 46, a recessed groove 48 to avoid interference with the second link 32 is formed. Because of this configuration, smooth movement of the second link 32 can be achieved.

The open-close mechanism 19 includes a latch pin 36. The latch pin 36 extends in a width direction as a rotation axis of a latch 27. The latch pin 36 is arranged on the open-close mechanism 19 side of the slot 42 and on a power supply side of the second link 32 to close a gap. Because of this configuration, a gap on the power supply side can be minimized when the circuit breaker 11 is turned off.

While the present invention has been described with reference to the definite number of embodiments, the scope of the present invention is not limited thereto and improvements and modifications of the embodiments based on the above disclosure are obvious to a person skilled in the art.

### REFERENCE SIGNS LIST

11 Circuit breaker
12 Case
13 Middle cover
14 Top cover
16 Fixed contact piece
17 Movable contact piece
18 Movable holder
19 Open-close mechanism
21 Fixed contact
22 Movable contact
26 Toggle link
27 Latch
31 First link
32 Second link
33 Toggle pin
34 Connection pin
36 Latch pin
37 Handle
38 Tension coil spring
41 Partition wall
42 Slot
46 Dividing wall
47 Opening
48 Recessed groove
51 One piece
52 The other piece
56 Support hole

1. A circuit breaker comprising:
a second link constituting another part of a toggle link in an open-close mechanism, having one end rotatably connected to a toggle pin and another end rotatably connected to a movable holder, and configured to open and close a contact by causing the movable holder to rotate; and
a partition wall disposed to separate the open-close mechanism side and the movable holder side from each other and having a slot for the second link formed,
wherein a direction in which the toggle pin extends is aligned with a width direction,
the second link is formed in an outer shape in which at a central portion of a path extending from one end to another end when viewed from the width direction, both an outline on a power supply side and an outline on a load side are drawn closer to a power supply side, and
the slot is set in such a way that a gap is minimized within a range not causing the slot to interfere with movement of the second link.

2. A circuit breaker, comprising:
a second link constituting another part of a toggle link in an open-close mechanism, having one end rotatably connected to a toggle pin and another end rotatably connected to a movable holder, and configured to open and close a contact by causing the movable holder to rotate; and
a partition wall disposed to separate the open-close mechanism side and the movable holder side from each other and having a slot for the second link formed,
wherein a direction in which the toggle pin extends is aligned with a width direction,
the second link is formed in an outer shape in which a central portion of a path extending from one end to another end when viewed from the width direction is bent into a V-shape to protrude toward a power supply side, and
the slot is set in such a way that a gap is minimized within a range not causing the slot to interfere with movement of the second link.

3. The circuit breaker according to claim 1, wherein the outer shape of the second link is an outer shape viewed from the width direction when the circuit breaker is turned on or is tripped.

4. The circuit breaker according to claim 1, wherein
a direction having one side and another side when viewed from the width direction serving as a power supply side and a load side, respectively is aligned with a vertical direction, and
an outer shape on an other end side of the second link viewed from the width direction when the circuit breaker is turned off extends in a direction orthogonal to the vertical direction.

5. The circuit breaker according to claim 1 comprising
a dividing wall facing the second link on a power supply side of the movable holder,
wherein on the dividing wall, a recessed groove to avoid interference with the second link is formed.

6. The circuit breaker according to claim 1, wherein
the open-close mechanism includes a latch pin extending in the width direction as a rotation axis of a latch, and
the latch pin is arranged on the open-close mechanism side of the slot and on a power supply side of the second link to close the gap.

7. The circuit breaker according to claim 2, wherein the outer shape of the second link is an outer shape viewed from the width direction when the circuit breaker is turned on or is tripped.

8. The circuit breaker according to claim 2, wherein
a direction having one side and another side when viewed from the width direction serving as a power supply side and a load side, respectively is aligned with a vertical direction, and
an outer shape on an other end side of the second link viewed from the width direction when the circuit breaker is turned off extends in a direction orthogonal to the vertical direction.

9. The circuit breaker according to claim 2 comprising
a dividing wall facing the second link on a power supply side of the movable holder,
wherein on the dividing wall, a recessed groove to avoid interference with the second link is formed.

10. The circuit breaker according to claim 2, wherein
the open-close mechanism includes a latch pin extending in the width direction as a rotation axis of a latch, and
the latch pin is arranged on the open-close mechanism side of the slot and on a power supply side of the second link to close the gap.
